(19) United States
(12) Patent Application Publication
(10) Pub. No.: US 2010/0018928 A1
(43) Pub. Date: Jan. 28, 2010

(54) DEVICE FOR PERFORMING SEPARATIONS AND METHODS OF MAKING AND USING SAME

(75) Inventors: Christopher C. Charlton, Benicia, CA (US); Geoff C. Gerhardt, Millbury, MA (US); Christopher C. Benevides, Tiverton, RI (US)

Correspondence Address: Waters Technologies Corporation;C/O WATERS CORPORATION, 34 MAPLE STREET - LG, MILFORD, MA, 01757, US

(73) Assignee: WATERS INVESTMENTS LIMITED, MILFORD MASSACHUSETTS, MA (US)

(21) Appl. No.: 11/719,381

(22) PCT Filed: Nov. 16, 2005
(86) PCT No.: PCT/US05/41615

§ 371 Date: Mar. 18, 2009

Related U.S. Application Data
(60) Provisional application No. 60/628,413, filed on Nov. 16, 2004.

(51) Int. Cl. B01D 15/08; B32B 37/04

(52) U.S. Cl. 210/661; 210/287; 156/293

(57) ABSTRACT

Embodiments of the present invention feature a device (11) for performing separations, methods of making and using such device (11). The device (11) includes a tubular member (13) having an exterior surface (17) and an interior surface (19). The interior surface (19) defines a chamber (25) having an outlet end (23) and an inlet end (21) for containing a separation media (15). The chamber (25) has a length dimension extending between the inlet end (21) and the outlet end (23), and at least one width dimension. A separation media (15) is constructed and arranged in a packing of particles in the chamber wherein the particles of the separation media (15) proximal to at least one of the inlet end (21) or outlet end (23) are fused to retain the separation media (15).

### CROSS REFERENCE TO RELATED APPLICATIONS

This application claims benefit of priority to U.S. Provisional Application No. 60/628,413, filed Nov. 16, 2004. The content of which is expressly incorporated herein by reference in its entirety.

### FIELD OF THE INVENTION

Embodiments of the present invention are directed to devices for performing separations which utilize particles in columns. Embodiments of the present invention have particular application as guard or trapping columns in which small device volumes are desirable.

### BACKGROUND OF THE INVENTION

Chromatography is a process in which chemical compounds are separated by differences in affinity. Typically, the differences are exhibited as the compounds are exposed to two different phases. One phase is mobile and one phase is immobile. The mobile phase, usually a gas or liquid, carries dissolved compounds past a immobile phase, usually a solid, and the dissolved compounds are retained or passed based on the affinity the compound has to the immobile phase.

The separation of compounds is reversible. The compositions leaving the immobile phase are able to redistribute and mix with the surrounding fluid. This redistribution of the concentrated compositions is known as band spreading. Band spreading is undesirable in that it tends to obscure compositions that are present in small concentrations.

Guard or trap columns are used to concentrate molecules for which further analysis is desired. These columns have a solid phase, usually a bed of packed particles, often referred to as a separation medium. The column is used to filter particulates and retain the target molecules. It is desirable to have guard columns with minimum volume to minimize band spreading.

### SUMMARY OF THE INVENTION

Embodiments of the present invention are directed to devices in the form of columns and cartridges, methods for performing separations, and methods for making columns and cartridges. The device of the present invention features minimum volumes and thereby minimizes band spreading.

One embodiment of the present invention features a device for performing separations. The device comprises a tubular member having an exterior surface and an interior surface, an outlet end and an inlet end. The interior surface defines a chamber having openings at the outlet end and an inlet end. A separation media is constructed and arranged in a packing of particles in the chamber. The particles of the separation media proximal to at least one opening, at the inlet end or outlet end, are fused to retain the separation media in the chamber. The device receives fluid through the opening at the inlet end, separates components of the fluid in the separation media, and discharges fluid through the opening at the outlet end.

As used herein the term “fused” means joined together. The fused particles retain the fused and unfused particles in the chamber due to the position at the opening. Devices of the present invention can be made without frits or with minimal frits. Frits are screens or discs with a plurality of openings allowing fluid to flow there through. Frits are used to retain particles in chambers of columns and cartridges. Frits do not participate in the separations and are normally considered dead volume. Thus, embodiments of the present invention feature a compact design with minimal frit volumes.

Preferably, the chamber has an axis between the inlet end and the outlet end and a radial dimension extending radially outward from the axis. Preferably, the fused particles is a section proximal to at least one of the outlet end or the inlet end. The section with the fused particles extends from the opening along the axis a distance effective to retain the fused and unfused particles. The effective distance is related to the opening size. Preferably, the openings define a circular plane having a center and a radius. The fused particles extend into the chamber a distance approximately equal to one to three times radius of the opening.

Preferably, the particles in the separation media are silica. Preferably, the particles in the fused section are cross linked by siloxane linkages. By way of example, without limitation, the particles of the fused section are cross linked by the reaction of a polydi-alkyl siloxane, such as polydimethylsiloxane.

Preferably, the particles of fused section have a surface chemistry as set forth in Formula I:

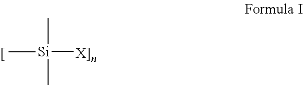

As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

However, fused particles of the present invention may be organic or hybrid in the sense of having features of both organic and silica. As used herein, the term “organic” means carbon based. Where the particles of said fused section are organic, the particles of fused section, preferably, have a surface chemistry as set forth in Formula II:

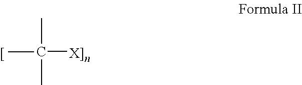

As used above, X is H or Y, and Y is hydroxyl, or —O—R₁- or O—CR₁,R₂,R₃—, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.

Embodiments of the present invention can be used with frits. For example, one embodiment of the present invention comprises a device having a tubular member, a first fitting, a separation media and a frit member. The tubular member has an exterior surface and an interior surface, an outlet end and an inlet end. The interior surface defines a chamber for containing a separation media having an inlet opening at the inlet end and an outlet opening at the outlet end. The exterior surface at the outlet end has first attachment means for cooperation with the first fitting. The first fitting has an cavity for receiving the outlet end of the tubular member and the frit member. The cavity has a sealing rim and a passage. The sealing rim engages the frit member or the frit member and the outlet end of the tubular member. The passage extends from the frit member to the outside of the first fitting to receive and discharge fluid from said tubular member and frit member. The first fitting has second attachment means for engaging the first attachment means of the tubular member to attach the tubular member and frit member to the sealing rim in sealing engagement. The frit member is positioned in the cavity of the first fitting against the sealing rim of the first fitting. The frit member prevents the separation media from traveling through the passage. The separation media comprising particles is packed in the chamber. The separation media has a section of fused particles at the inlet opening to prevent the separation media from exiting the chamber of the tubular member.

Preferably, the passage of the first fitting has outlet connection means for placing an outlet member capable of receiving fluid discharged from the tubular member in communication with the outlet end of said tubular member and frit member. A preferred outlet connection means is an outlet ferrule receiving section. The outlet ferrule receiving section has a conical shape for receiving and compressing an outlet ferrule. And, the outlet connection means of said passage preferably comprises a threaded section having threads for receiving cooperating threads of an outlet ferrule compression fitting.

Devices of the present invention are well suited to couple fused silica capillaries. For example, one embodiment of the present invention features an outlet member that is a fused silica capillary. Preferably, the fused silica capillary has an outlet ferrule which outlet ferrule is received in the outlet ferrule receiving section of the passage. Preferably, the outlet member has an outlet ferrule compression fitting having threads cooperating with threads of the threaded section of the passage.

Preferably, the device further comprises an inlet connector means. For example, one preferred inlet connector means comprises an inlet ferrule. The inlet ferrule is fitted to the exterior of the tubular member and sealing engages the tubular member upon compression. Preferably, the inlet connector means further comprises an inlet ferrule compression screw. The inlet compression screw has threads for cooperation with an inlet ferrule compression fitting to compress the inlet ferrule in sealing engagement with the exterior of the tubular member.

Embodiments of the present invention can be made with small volumes. One embodiment of the invention features an inlet compression screw having a inlet end toward the inlet ferrule and an outlet end toward the outlet end of the tubular member. The inlet compression screw has a hollow for receiving said outlet connection means. Thus, the device allows the nesting of fitting within fitting minimizing volume.

One further embodiment of the present invention features a method of making a device for performing separations. The method comprises the steps of providing a tubular member having an exterior surface and an interior surface and having a outlet end and an inlet end. The interior surface defines a chamber for containing a separation media. The chamber has an inlet opening at the inlet end and an outlet opening at the outlet end. The method further comprises the step of packing particles in the chamber wherein the particles of comprise a separation media and at least some particles are proximal to at least one inlet opening or outlet opening. The method further comprises the step fusing particles proximal to at least one of the inlet opening or outlet opening to retain the separation media.

Preferably, the method further provides the step of providing a frit at one of the inlet opening or outlet opening. The particles are packed against the frit and the particles at the opening without the frit are fused. The fused particles, preferably, form a section within the packing.

Preferably, the particles in are silica, or organic or having features of both organic and silica compositions. As used herein, the term “hybrid chemistry” refers to particles having a carbon and silica composition. The silica particles are preferably cross linked by siloxane linkages. For example, one embodiment of the present invention features the step of reacting the particles with a polydi-alkyl siloxane, such as, polydimethylsiloxane.

A further embodiment of the present invention is a method of using concentrating a compound or preventing material from flowing into a downstream instrument. The method comprises the steps of providing a device having a tubular member having an exterior surface and an interior surface, an outlet end and an inlet end. The interior surface defines a chamber having openings at the outlet end and an inlet end. A separation media is constructed and arranged in a packing of particles in the chamber. The particles of the separation media proximal to at least one opening, at the inlet end or outlet end, are fused to retain the separation media in the chamber. The device receives fluid through the opening at the inlet end, separates components of the fluid in the separation media, and discharges fluid through the opening at the outlet end. Embodiments of the present method are useful for coupling a liquid chromatography instrument with detectors such as mass spectrometers, as a pre analytical column guard column or trapping column for concentrating compounds from dilute samples and the like. Embodiments of the present invention feature a compact design making the invention ideally suited for small scale, less than one micro liter per minute flow rates.

These and other features and advantages will be apparent upon reviewing the drawings and studying the detailed description that follow.

### BRIEF DESCRIPTION OF THE DRAWING

FIG. 1 depicts a device in cross section embodying features of the present invention.

FIG. 2 depicts fused and unfused particles embodying features of the present invention.

### DETAILED DESCRIPTION OF THE INVENTION

The present invention will be described in detail as a trapping column for small scale high pressure or high performance liquid chromatography (HPLC). HPLC is performed at pressures of up to approximately 4,000 pound per square inch. Embodiments of the present invention have application at very high or ultra pressures of greater than 4,000 and up to 15,000 pounds per square inch. However, the description herein is directed to a preferred embodiment and the present invention has other uses and applications.

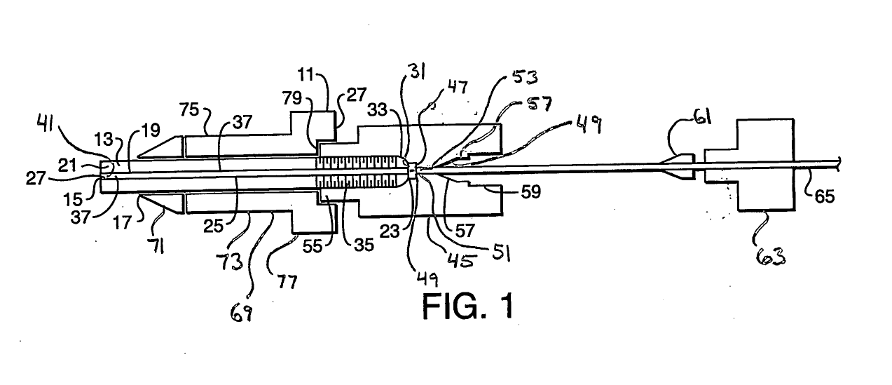

Turning now to FIG. 1, a device, generally designated by the numeral 11, is depicted in cross section. The device has the following major elements: a tubular member 13 and a separation media 15.

The device 11 is for performing separations as trapping column or guard column. Trapping columns and guard columns are known in the art. Trapping columns are used to concentrate compounds from dilute samples for further analysis. Guard columns are used to filter or remove compounds and particulates from a solution to protect instruments which may be impaired by such particles or compounds.

Tubular member 13 has an exterior surface 17 and an interior surface 19. Tubular member 13 also has an inlet end 21 and an outlet end 23. The interior surface 19 defines a chamber 25 having an inlet opening 27 and an outlet opening 31. The chamber 25 is preferably cylindrical in shape having an axis extending between the inlet opening 27 and outlet opening 31 and a radius extending from the axis to the interior surface 19. Although a cylinder has been depicted, those skilled in the art will recognize that other shapes and forms are possible. The chamber 25 contains the separation media 15.

Tubular member 13 is preferably a stainless steel tube with an outside diameter of 1/64 to ¼ inch, or, more preferably, approximately 1/16 inch. The inside diameter is preferably 0.0001 to 0.05 inch, and more preferably, approximately 0.005 to 0.007 inch. The tubular member 13 preferably has a length of 5 to 40 mm, and, most preferably, 10 to 30 mm, and most preferred, approximately 20 mm.

The outlet end 23 of tubular member 13 has a tapered section 33 and first attachment means in the form of a threaded section 35. The threaded section 35 is constructed and arranged to cooperate with a first fitting 45 to be described later in this document.

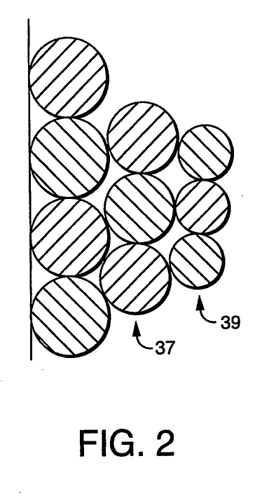

Separation media 15 constructed and arranged as a packing of particles in chamber 25. FIG. 2 depicts particles 37 of said separation media 15, proximal to at least one of said inlet opening or outlet opening, that are fused. The fused particles 37 retain the separation media 15 comprised of fused particles 37 and unfused particles 39 in the chamber 25.

The fused particles 37 and unfused particles 39 can be of any material commonly employed as a separation media. Common materials used as particles are, by way of example, without limitation, silica, organic polymers, aluminium, zirconium, and combinations thereof. The unfused particles have a mean particle size known in the art.

A preferred separation media is comprised of fused particles 37 and unfused particles 39 that are silica. Referring now to FIGS. 1 and 2, the fused particles 37 occupy a fused section 41 of the separation media 15 proximal to the inlet opening 27. This fused section 41 extends into the separation media to a depth of approximately one to three times the width of the inlet opening 27.

In the event the particles in said fused section 41 are silica, the fused particle 37 are preferably cross linked by siloxane linkages. For example, the fused particles 37 are cross linked by the reaction of a polydi-alkyl siloxane. A preferred polydi-alkyl siloxane is polydimethylsiloxane wherein fused particles 37 of fused section 41 have a surface chemistry as set forth in Formula I:

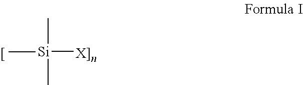

As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

In the event the fused particles 37 are organic, a preferred particle surface chemistry is set forth in Formula II:

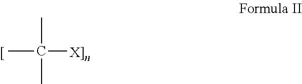

As used above, X is H or Y, and Y is hydroxyl, or —O—R₁- or O—CR₁,R₂,R₃-, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.

Preferably, the device 11 comprises further features and elements. For example, without limitation, one embodiment of the present invention further comprises a first fitting 45 and a frit member 47.

First fitting 45 has a first fitting opening 49 for receiving the outlet end 23 of the tubular member 13 and frit member 47. As used herein, the term “frit member” means porous membranes, screens, metallic discs with holes and the like. A preferred frit member 47 is a stainless steel metal disc. The frit member has a thickness of approximately 0.010 inches and is approximately 0.020 inches in diameter. However, other dimensions can readily be used depending on the size of the tubular member 13 and first fitting 45.

First fitting 45 preferably made of machine-able metals or polymeric organic plastics. A preferred plastic is polyetheretherketone commonly known as PEEK.

First fitting 45 has a first fitting opening 49 extending therethrough. The first fitting opening 49 has a sealing rim 51 and a passage 53. The sealing rim 51 is constructed and arranged to engage the frit member 47. In the alternative the sealing rim 51 may engage the frit member 47 and the outlet end 23 of said tubular member 13. The passage 53 is for receiving and discharging fluid from said tubular member and frit member 47.

Preferably, the first fitting 45 has second attachment means in the form of threaded passage section 55 for engagement with said first attachment means of the tubular member 13 in the form of threaded section 35. The threaded passage section 55 and threaded section 35 cooperate to attach the tubular member 13 to the sealing rim 51 in sealing engagement with a frit member 47. Those skilled in the art will readily recognize that first and second attachment means may take several forms. For example, attachments means may comprise interlocking ridges, cam surfaces and the like.

Preferably, the frit member 47 in said opening 49 of the first fitting 45 is interposed between said sealing rim 51 and said outlet end 23 of said tubular member 13. The frit member 47 is for retaining a separation media 15 in the chamber at one opening as the fused section 37 retains the separation media at the opposite end.

Thus, the separation media 15 comprising particles packed in said chamber 25 have a section of fused particles 37 at the inlet opening 27 to prevent the separation media 15 from exiting the chamber 25. The fuse particle section 37 is able to participate in the separation process and is not an inert volume that promotes band spreading.

Preferably, the passage 53 of the first fitting 45 has outlet connection means for placing an outlet member, such as a instrument [not shown] or fused silica capillary 65 capable of receiving fluid discharged from the tubular member 13 and frit member 47.

One preferred outlet connection means is an outlet ferrule receiving section 57 incorporated in the passage 53. The outlet ferrule receiving section 57 has a conical shape for receiving and compressing an outlet ferrule 61. The outlet ferrule 61 may participate in holding the first fitting 45 and the tubular member 13 in communication with other conduits and instruments including, by way of example, fused silica capillary tubing, metal tubing, instrument and detector inlets, mass spectrometers and the like.

By way of example, the outlet connection means of the passage 53 comprises a threaded section 59 having threads for receiving cooperating threads of an outlet ferrule compression fitting 63.

The device 11 is ideally suited for use in communication with a fused silica capillary 65. Fused silica capillary 65 is passed into the passage 53 and butted up against the frit member 47 or the passage 53.

Preferably, the device 11 further comprising an inlet connector means, generally designated by the numeral 69. The inlet connector means 69 may take several forms. As depicted, the inlet connector means 69 comprises a inlet ferrule 71 and an inlet ferrule compression screw 73.

Inlet ferrule 71 is fitted to the exterior surface 17 of said tubular member 13. Inlet ferrule 71 sealing engages the exterior surface 17 of tubular member 13 as the inlet ferrule 71 is compressed.

Inlet ferrule compression screw 73 is also fitted to the exterior surface 17 of tubular member 13. Inlet compression screw 73 has threads for cooperation with an inlet ferrule compression fitting [not shown] or threads in a housing of an instrument [not shown] to compress said inlet ferrule 71 in sealing engagement with the exterior surface 17 of the tubular member 13.

Preferably, the inlet compression screw 73 has a inlet end 75 toward said inlet ferrule 71 and an outlet end 77 toward said outlet end 23 of the tubular member 13. To make the device 11 more compact, the inlet compression screw 73 has a hollow 79 for receiving a portion of the first fitting 45. Inlet compression screw 73 is preferably made of machine-able metal, and preferably stainless steel. Inlet ferrule 71 and outlet ferrule 61 are preferably metal.

To facilitate handling and tightening, one or more of first fitting 45 and inlet compression screw 73 and outlet ferrule compression fitting 63 have ridged surfaces or nut faces or wing projections.

Device 11 is made by packing a separation media 15 into the tubular member 13. Preferably, the tubular member 13 is placed into a first fitting 45 with a frit member 47. The particles 39 are slurry packed into the chamber 25 and packed under pressure against the frit member 47. Once fully packed, the particles 39 are bonded with a bonding agent to form a fused section 39.

A preferred bonding agent for silica particles is a polydialkylsiloxane, and most preferably, polydimethylsiloxane. The bonding agent is preferably diluted in solvent such as ethyl acetate and the dilute solution is placed in to the chamber 25. The bonding agent solidifies and forms the fused section 39 in chamber 25.

The inlet compression screw 73 and inlet ferrule 71 are next placed on the tubular member 13. Preferably, a fused silica capillary 65 fitted with a outlet ferrule 61 and outlet ferrule compression fitting 63 is received in the passage 53. In use, the device 11 unfused particles 39 of the separation media 15 are retained in the chamber 25 by the fused section 37. Retaining the unfused particles 39 in the chamber 25 can be critical when the device is in storage or in shipping or being handled.

The device is placed in fluid communication with a source of fluid [not shown] and receives fluid at the inlet end 21 of the tubular member 13. In the event such fluid has particulates, such particulates are removed and retained in the separation media 15. Fluid exits the device 11 at the outlet end 23 and into an instrument [not shown] or further conduit means such as a fused silica capillary 65.

Thus, preferred embodiments of the present invention have been described in detail with the understanding that features of the present invention are capable of being modified and altered. Therefore, the invention should not be limited to the specific description herein but should encompass the subject matter of the following claims and their equivalents.

1. A device for performing separations comprising
a tubular member having an exterior surface and an interior surface, said interior surface defining a chamber having a outlet end and an inlet end for containing a separation media, said chamber having a length dimension extending between said inlet end and outlet end, and at least one width dimension; and,
separation media constructed and arranged in a packing of particles in said chamber wherein said particles of said separation media proximal to at least one of said inlet end or outlet end are fused to retain said separation media.

2. The device of claim 1 wherein said particles in said separation media are silica.

3. The device of claim 2 wherein said particles in said fused section are cross linked by siloxane linkages.

4. The device of claim 3 wherein said particles in said fused section are cross linked by the reaction of a polydi-alkyl siloxane.

5. The device of claim 4 wherein said polydi-alkyl siloxane is polydimethylsiloxane.

6. The device of claim 1 wherein said particles of fused section have a surface chemistry as set forth in Formula I: 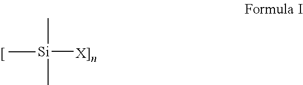
As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

7. The device of claim 1 wherein said particles of said fused section are organic.

8. The device of claim 1 wherein said particles of said fused section have a surface chemistry as set forth in Formula II: 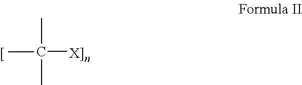
As used above, X is H or Y, and Y is hydroxyl, or —O—R₁- or O—CR₁,R₂,R₃-, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.

9. A device for performing separations comprising:
a tubular member having an exterior surface and an interior surface, said interior surface defining a chamber for containing a separation media, said tubular member having a outlet end and an inlet end, said exterior surface at said outlet end having first attachment means for cooperation with a first fitting;
a first fitting having an opening for receiving the outlet end of said tubular member and a frit member, said opening having a sealing rim and a passage, said sealing rim to engage said frit member and said outlet end of said tubular member, and said passage for receiving and discharging fluid from said tubular member and frit member, said first fitting having second attachment means for engagement with said first attachment means of said tubular member to attach said tubular member to said sealing rim in sealing engagement with a frit member;
a frit member in said opening of said first fitting interposed between said sealing rim of said first fitting and said outlet end of said tubular member, said frit member for retaining a separation media;
a separation media comprising particles packed in said chamber and having a section of fused particles at said inlet end to prevent said separation media from exiting the chamber.

10. The device of claim 9 wherein said passage of said first fitting has outlet connection means for placing an outlet member capable of receiving fluid discharged from tubular member in communication with said outlet end of said tubular member and frit member.

11. The device of claim 10 wherein said outlet connection means of said passage is an outlet ferrule receiving section said outlet ferrule receiving section having a conical shape for receiving and compressing an outlet ferrule.

12. The device of claim 11 wherein said outlet connection means of said passage comprises a threaded section having threads for receiving cooperating threads of an outlet ferrule compression fitting.

13. The device of claim 12 wherein said outlet member is a fused silica capillary.

14. The device of claim 13 wherein said fused silica capillary has an outlet ferrule which outlet ferrule is received in said outlet ferrule receiving section of said passage.

15. The device of claim 14 wherein said outlet member has an outlet ferrule compression fitting having threads cooperating with said threads of said threaded section.

16. The device of claim 9 further comprising an inlet connector means.

17. The device of claim 16 wherein said inlet connector comprises an inlet ferrule said inlet ferrule fitted to the exterior of said tubular member and sealing engaging said member as said ferrule is compressed.

18. The device of claim 17 wherein said inlet connector comprises an inlet ferrule compression screw, said screw having threads for cooperation with an inlet ferrule compression fitting to compress said inlet ferrule in sealing engagement with said exterior of said tubular member.

19. The device of claim 18 wherein said inlet compression screw has a inlet end toward said inlet ferrule and an outlet end toward said outlet end of said tubular member said inlet compression screw having a hollow for receiving said outlet connection means.

20. The device of claim 9 wherein said particles in said separation media are silica.

21. The device of claim 20 wherein said particles in said fused section are cross linked by siloxane linkages.

22. The device of claim 21 wherein said particles in said fused section are cross linked by
the reaction of a polydi-alkyl siloxane.

23. The device of claim 22 wherein said polydi-alkyl siloxane is polydimethylsiloxane.

24. The device of claim 9 wherein said particles of said fused section have a surface chemistry as set forth in Formula I: 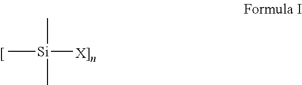
As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

25. The device of claim 9 wherein said particles are organic polymers.

26. The device of claim 25 wherein said particles of said fused section have a surface chemistry as set forth in Formula II: 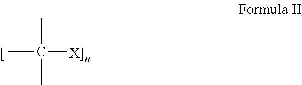
As used above, X is H or Y, and Y is hydroxyl, or —O—R₁- or O—CR₁,R₂,R₃-, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.

27. A method of performing separations comprising the steps of:
a.) providing a device having a tubular member and a separation media, said tubular member having an exterior surface and an interior surface, said interior surface defining a chamber having a outlet end and an inlet end for containing a separation media, said chamber having a length dimension extending between said inlet end and outlet end, and at least one width dimension; and,
said separation media constructed and arranged in a packing of particles in said chamber wherein said particles of said separation media proximal to at least one of said inlet end or outlet end are fused to retain said separation media.
b.) passing a fluid through said separation media to effect at least one separation.

28. The method of claim 27 wherein said particles in said separation media are silica.

29. The method of claim 28 wherein said particles in said fused section are cross linked by siloxane linkages.

30. The method of claim 29 wherein said particles in said fused section are cross linked by the reaction of a polydi-alkyl siloxane.

31. The method of claim 30 wherein said polydi-alkyl siloxane is polydimethylsiloxane.

32. The method of claim 31 wherein said particles of fused section have a surface chemistry as set forth in Formula I: 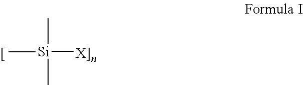
As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

33. The method of claim 27 wherein said particles of said fused section are organic.

34. The method of claim 33 wherein said particles of fused section have a surface chemistry as set forth in Formula II: 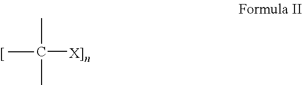
As used above, X is H or Y, and Y is hydroxyl, or —O—R₁- or O—CR₁,R₂,R₃-, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.

35. A method of making a separation device comprising the steps of:
providing a device having a tubular member, said tubular member having an exterior surface and an interior surface, said interior surface defining a chamber having a outlet end and an inlet end for containing a separation media, said chamber having a length dimension extending between said inlet end and outlet end, and at least one width dimension; and,
forming a separation media constructed and arranged as a packing of particles in said chamber; and,
fusing said particles of said separation media proximal to at least one of said inlet end or outlet end to form a fused section to retain said separation media in said chamber.

36. The method of claim 35 wherein said particles in said separation media are silica.

37. The method of claim 36 wherein said particles in said fused section are cross linked by siloxane linkages.

38. The method of claim 37 wherein said particles in said fused section are cross linked by the reaction of a polydi-alkyl siloxane.

39. The method of claim 38 wherein said polydi-alkyl siloxane is polydimethylsiloxane.

40. The method of claim 39 wherein said particles of fused section have a surface chemistry as set forth in Formula I: 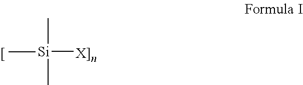
As used above, X is H or Y, and Y is hydroxyl, or —O—R₁- or O—SiR₁,R₂,R₃-, or O—(SiR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are silicon atoms, of the same or adjacent particles, hydrogen or impurities.

41. The method of claim 35 wherein said particles of said fused section are organic.

42. The method of claim 41 wherein said particles of fused section have a surface chemistry as set forth in Formula II: 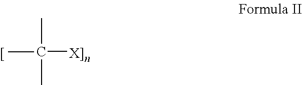
As used above, X is H or Y, and Y is hydroxyl, or —O—R₁- or O—CR₁,R₂,R₃-, or O—(CR₁R₂)ₙ—O— wherein R₁, R₂, and R₃ are selected from the group consisting of alkyl, alkenyl, alkynyl, aromatic, amino alkyl, amino alkenyl, amino alkynyl, and carbonyl, alcohol and carboxylic acid derivatives thereof having one to twenty five atoms, and the letter “n” represents an integer from 1 to infinity and any vacant valences are carbon atoms, of the same or adjacent particles, hydrogen or impurities.
